(19) United States
(12) Patent Application Publication
(10) Pub. No.: US 2021/0362080 A1
(43) Pub. Date: Nov. 25, 2021

(54) AUTONOMOUSLY CONTROLLED SELF-CLEANING FILTER APPARATUS

(71) Applicant: TAVLIT PLASTIC LTD., Yavne (IL)

(72) Inventors: Moshe GRANOT, Moshav Adanim (IL); Yotam GRANOT, Moshav Adanim (IL)

(21) Appl. No.: 16/979,560

(22) PCT Filed: Mar. 12, 2018
(86) PCT No.: PCT/IL2018/050290

§ 371 Date: Sep. 10, 2020

(30) Foreign Application Priority Data
Mar. 12, 2017 (IL) 251110

(51) Int. Cl. B01D 29/68; B01D 29/60; B01D 35/157; B01D 29/94; B01D 35/30

(52) U.S. Cl. CPC B01D 29/682; B01D 29/606; B01D 35/1573; B01D 29/684; B01D 2201/56; B01D 35/30; B01D 2201/302; B01D 2201/165; B01D 29/94

(57) ABSTRACT

The present invention relates to fluid filtering apparatuses, for applications such as water filtration, that utilizes screen filters, and in particular, to such a filtering apparatus having autonomously controlled self-cleaning capabilities. A self-cleaning filter apparatus including a filtering housing for filtering a fluid across a screen filter, a flushing chamber for housing filtered debris, and a control assembly for autonomously switching between filtering phases of the filter based on the differential pressure across the filter that is channeled along portions of the control assembly, the control assembly including a flush valve assembly, a three position two way (3/2) valve and a differential pressure (DP) switch.

### FIELD OF THE INVENTION

The present invention relates to fluid filtering apparatuses, for applications such as water filtration, that utilizes screen filters, and in particular, to such a filtering apparatus having autonomously controlled self-cleaning capabilities.

### BACKGROUND OF THE INVENTION

The present invention relates to a self-cleaning screen filter apparatus for filtering a flowing fluid, in particular water. Self-cleaning screen filter systems, for example such as that disclosed in U.S. Pat. No. 4,060,483 to Barzuza are automated utilizing controllable valves, and motors to control the onset of the cleaning cycles. Such systems use controllers and differential pressure gauges in order to control the onset of and to perform the self-cleaning functions. Such automated self-cleaning filtering systems require high-end electronic and/or hydraulic devices for undertaking such self-cleaning capabilities. This renders the apparatuses expensive and dependent on internal and/or external electric source, and therefore not feasible for many filtering application.

### SUMMARY OF THE INVENTION

The present invention overcomes the deficiencies of the background art by providing a standalone autonomously controlled self-cleaning screen filter apparatus. The filter apparatus is configured to channel and harness both the fluid flow and the differential pressure, built up during the filtration process to control the operations of the filter apparatus. Specifically, the differential pressure built up as a results of the filtering process, is channeled throughout the filter apparatus to provide for autonomously controlling the filter apparatus cycling and/or switching between a filtering phase and a cleaning phase of the filter.

Accordingly, the filter apparatus of the present invention provides for establishing and harnessing a dynamic differential pressure flux to autonomously switch between the filter apparatus phases, namely, switching between filtering phase and cleaning phase, and to further drive the self-cleaning function of the filter apparatus.

An object of the present invention is to provide a self-cleaning screen filter apparatus that does not require expensive controller(s) that activate valves and motors, during the cleaning and flushing stages of a self-cleaning screen filter apparatus.

The present invention provides a self-cleaning screen filter apparatus that establishes, utilizes and channels the available systemic fluid differential pressure to autonomously initiate, drive and regulate the self-cleaning cycle and return back to the filtering phase.

Embodiments of the present invention overcome the deficiencies of the background art by providing a non-expensive, standalone means where the energy in the flowing fluid and the differential pressure flux is harnessed and channeled across different portions of the filter apparatus. The differential pressure flux is therefore used to drive the self-cleaning phase without the need for electronic controllers, valves, or motors.

Embodiments of the present invention overcome the deficiencies of the background art self-cleaning screen filters that utilize automated valves to open and/or close a flush valve so as to expose the filter housing to atmospheric pressure to initiate the self-cleaning phase of the filter apparatus. In some state of the art applications a motor is further used to rotate the cleaning elements and suction nozzles cleaning the filter surface. The present invention overcomes the prior filters in that it does not utilize any external means to control a flush valve or to rotate the suction nozzles.

The present invention is characterized in that it utilizes the pressure differential flux between different portions of the filter apparatus to open and close the flush port. Specifically the flush port is provided on a piston assembly; the piston assembly therefore opens and closes the flush port. Control of the piston assembly is provided by introducing a control assembly including a 3/2 valve and a hydro mechanical DP switch. The control assembly therefore provides for establishing and channeling differential pressure flux state so as to allow the flush port to be opened and/or closed by the piston assembly. Control of the piston assembly is based on harnessing the filter's own differential pressure to establish differential pressure across the piston assembly's piston plate.

In some embodiments the control assembly may further include a three position valve relay to further enhance control of the control assembly in channeling the differential pressure flux exerted across portions of the piston assembly.

In some embodiments the control assembly may further include a further switching member to facilitate additional control of the 3/2 valve to further enhance the overall control of the control assembly in channeling the differential pressure flux exerted across portions of the piston assembly.

In embodiments the filter apparatus may be configured to utilize any form or size of a screen filter for example including but not limited to mesh, wire, the like or any combination thereof.

In embodiments the filter apparatus may employ at least one or more screen filters configured to filter an unfiltered flowing fluid in a directional manner along an internal surface of the filter or an external surface of the filter.

In embodiments of the present invention may utilize a plurality of screen filters that may consist of a number of layered screen filters.

In embodiments of the present application may utilize a plurality of screen filters that may be configured and/or placed in series, and/or succession relative to one another.

In embodiments, the present invention may further provide a controllable cleaning nozzles configuration that is provided for controlling the timing of cleaning suction nozzles associated with the filter apparatus so as to ensure that the filter screen is cleaned during the cleaning phase.

Embodiments of the present invention provide a fluid filter cleaning apparatus comprising: a housing having an inlet port, an outlet port and a valved flushing outlet, the housing defining a fluid passage between the ports via a filtering member; a filter cleaning module that is movably mounted within the housing and having at least one suction nozzle adapted to move in close proximity to the surface of the filtering member and to provide a fluid flow path between the intake portion and the valved cleaning outlet; and a fluid responsive means positioned in the flow path adapted to cause the movement of the cleaning body; the arrangement being such that when the filter is at least partly clogged the valved flushing outlet is opened causing fluid to flow via the suction nozzle through the cleaning module into the cleaning outlet and thereby to actuate the fluid responsive means to cause the movement of the cleaning module; and wherein the movement of the cleaning module provides for actuating the control member so as to control the degree of flow through the nozzles or to determine which nozzle is active.

An aspect of the present invention provides a control module for a self-cleaning screen filter that is capable of channeling the differential pressure so as to autonomously switching between the filtering phase and cleaning phase. The control module comprises a differential pressure switch, a three position two way valve and flush valve assembly featuring a piston assembly.

An aspect of the present invention provides a cleaning module for a self-cleaning screen filter apparatus the cleaning module comprising: at least one suction nozzle having a flow path between a first end and a second end associated over a filtering surface of the screen filter and configured for suctioning debris away from the screen filter, the suction nozzle having a first end associated over the filtering surface of the screen filter; a second end in communication with a retrieval pipe; the retrieval pipe in fluid communication with the suction nozzle and configured to receive debris flow collected with the suction nozzle; and a nozzle controlling member placed along and intercepting the nozzle's flow path and configured so as to control the flow through the suction nozzle.

For ease of demonstration embodiments will be described with respect to screen filter that utilizes an inside out filter flow therein the filtering surface is disposed along an internal surface of a filter. However, embodiments of the present invention are not limited to an inside-out filtering direction alone, therefore embodiments of the present invention may similarly be configured and/or adjusted to provide for an outside-in filtering direction across the screen filter.

Within the context of this application the term flowing fluid may interchangeably refers to any liquid, gas, air, or a mixture thereof. While for eases of understanding the present invention is primarily described with respect to liquid in the form of water, however, the presently invention may be utilized to filter any form of a flowing fluid and therefore is not limited to use as a water filter system.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a schematic block diagram of a filter apparatus according to an embodiment of the present invention;

FIG. 1B is a schematic block diagram of a filter apparatus according to an embodiment of the present invention;

FIG. 2A-B are exploded views showing a schematic illustrative diagrams of the core of a filter apparatus according to embodiments of the present invention;

FIG. 3A-G are various views showing a schematic illustrative diagrams of the core parts for removing debris from the filter body of a filter apparatus according to embodiments of the present invention;

FIG. 4 is a partial exploded view showing the different pressure zones of a filter apparatus according to embodiments of the present invention;

FIG. 5-7 are flowcharts describing the control assembly and its dynamic control of the differential pressure flux used to autonomously control the filtering apparatus according to embodiments of the present invention;

FIG. 8A-B are close up views showing a schematic illustrative diagrams of an optional control assembly according to embodiments of the present invention; and

FIG. 9-11 are flowcharts describing the functioning of the control assembly of FIG. 8A-B and its dynamic control of the differential pressure flux used to autonomously control the filtering apparatus according to embodiments of the present invention.

### DESCRIPTION OF THE PREFERRED EMBODIMENTS

The principles and operation of the present invention may be better understood with reference to the drawings and the accompanying description. The following figure reference labels are used throughout the description to refer to similarly functioning components are used throughout the specification hereinbelow.
10 raw unfiltered fluid (granulated arrow);
12 filtered fluid (white arrow)
14 filtered debris (black arrow);
100,101 fluid filter apparatus;
106 filtering member;
106f filtering surface;
110 filter housing;
111 interface member
112 fluid inlet (unfiltered);
114 fluid outlet (filtered);
116 debris flow passageway;
120 debris retrieving module;
122 debris suction module;
124 debris suction nozzle member(s);
124s nozzle spring;
126 nozzle controlling member;
126a control member housing;
126o recess opening;
128 debris retrieving pipe;
128a retrieving pipe first portion;
128b retrieving pipe debris flow recess;
128c retrieving pipe cap;
130 debris flushing chamber;
132 lower surface;
134 debris ejection pipe;
134a ejection pipe end;
134R ejection pipe rotation;
134L removal pipe linear motion;
136 debris removal opening;
138 mediating (piston) coupling member;
140 three position hydraulic valve relay;
150 filter apparatus controller assembly;
152 flush valve assembly;
152h flush valve housing;
154 flush valve exit port;
154a flush port open area;
156 port;
158 flush valve piston assembly;
158a upper piston plate portion;
158c lower piston plate portion/piston cap
158b, 158d, 158e piston shaft members;
159 cap;
159a cap shaft;
159b cap shaft spring;
159c cap internal flow channel;
160 three way two position valve (3/2 valve);
162 3/2 control shaft;
162a port to flush valve assembly;
162b port to systemic High Pressure;
162c port to Atmosphere;
165 Differential Pressure Switch;
165a high pressure port;
165b low pressure port;
165s DP spring;
165H DP High Pressure zone;
165L DP Low Pressure Zone;
166 DP shaft;
167 DP indicator;
170 switch member;
252 flush valve assembly;
252d flush valve divider;
252h flush valve housing;
254 flush valve exit port;
254a atmospheric port open area;
256 port
258 flush valve piston assembly;
258a upper piston plate;
258b piston shaft member;
258c lower piston plate plug/cap;
259 cap;

A self-cleaning screen filter apparatus provides for filtering upstream raw “unfiltered” water that is introduced into a filter housing through an inlet to flow across a screen filter so as to filter debris out of the upstream water flow to produce clean “filtered” water that flow out to downstream through a clean water outlet. Such self-cleaning filter apparatuses provide for cleaning the filter and removing the debris using a cleaning apparatus internal to the filter that removes debris lodged and/or accumulated on the screen filter, and thereafter flushes the debris out of the filter apparatus through a dedicated flush outlet.

Embodiments of the present invention provide a self-cleaning filter apparatus capable of autonomously switching between the filtering phase and the cleaning phase. Switching between filter's phases is solely accomplished by managing the differential pressure provided by the flow of water across the filtering member.

Embodiments of the present invention further provide for controlling the cleaning apparatus utilized in cleaning the screen filter, so as to maximize filter surface that is cleaned.

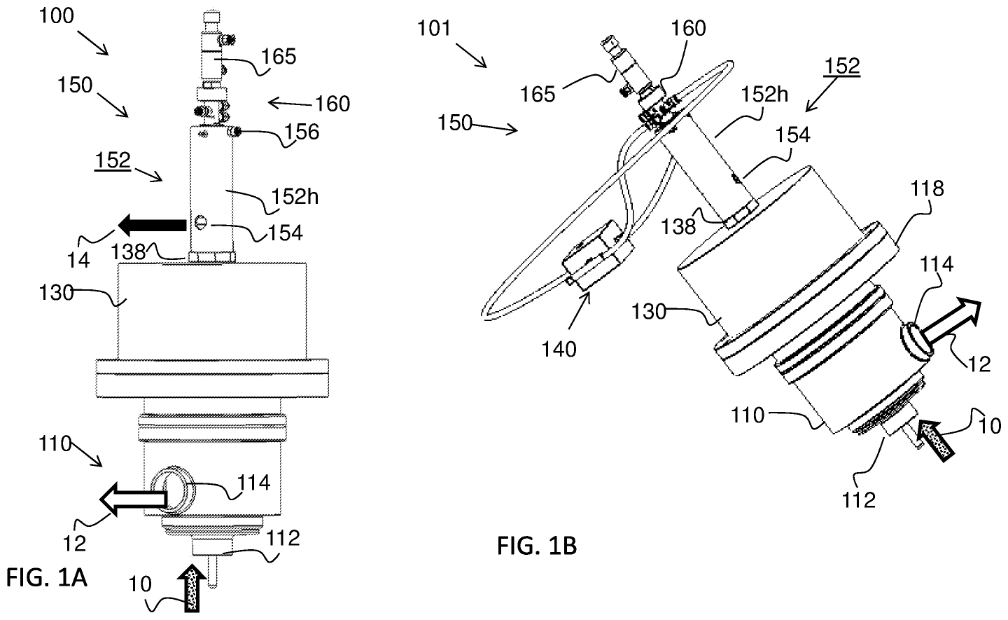

Referring now to the drawings where the filter apparatus 100, 101 are described in detail with reference to FIG. 1-4 showing a schematic diagram of the filter apparatus showing various illustrative views of the filter apparatus according to embodiments of the present invention. The working of the filter assembly 100 is further depicted in flowcharts found in FIG. 5-7.

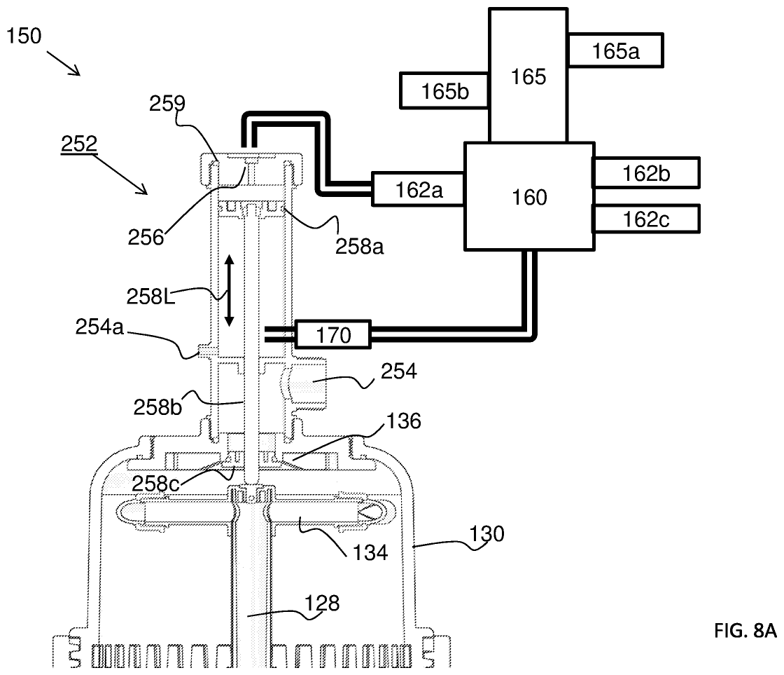

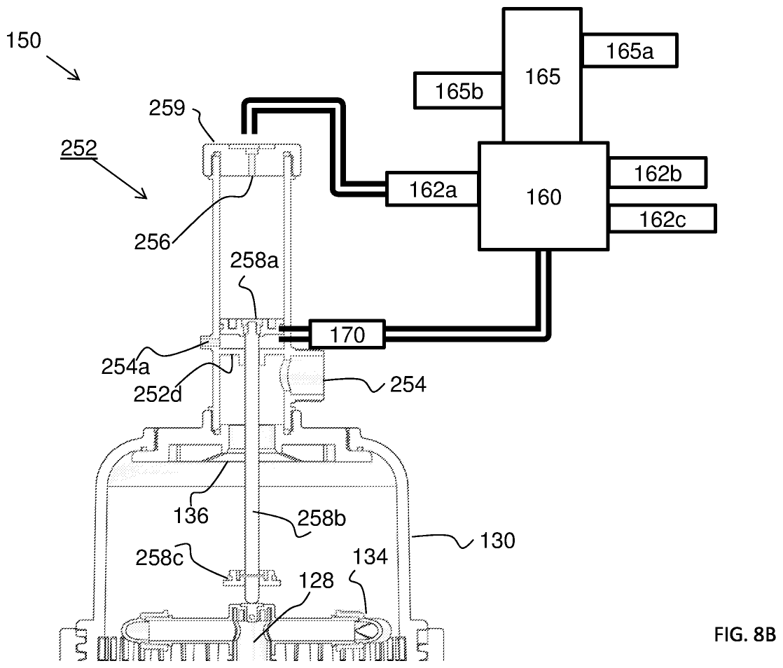

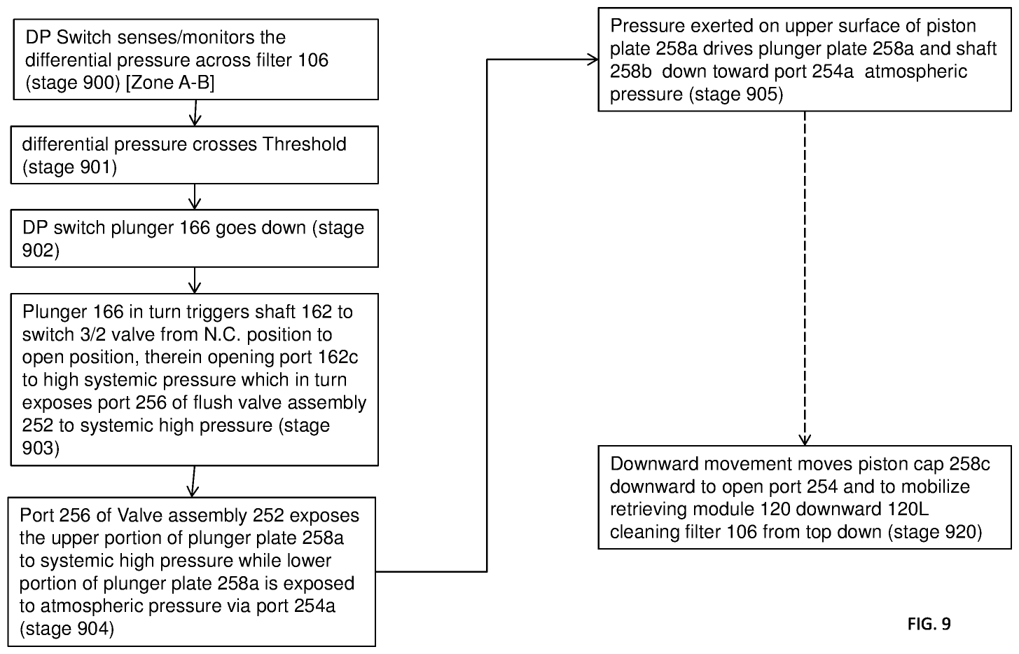

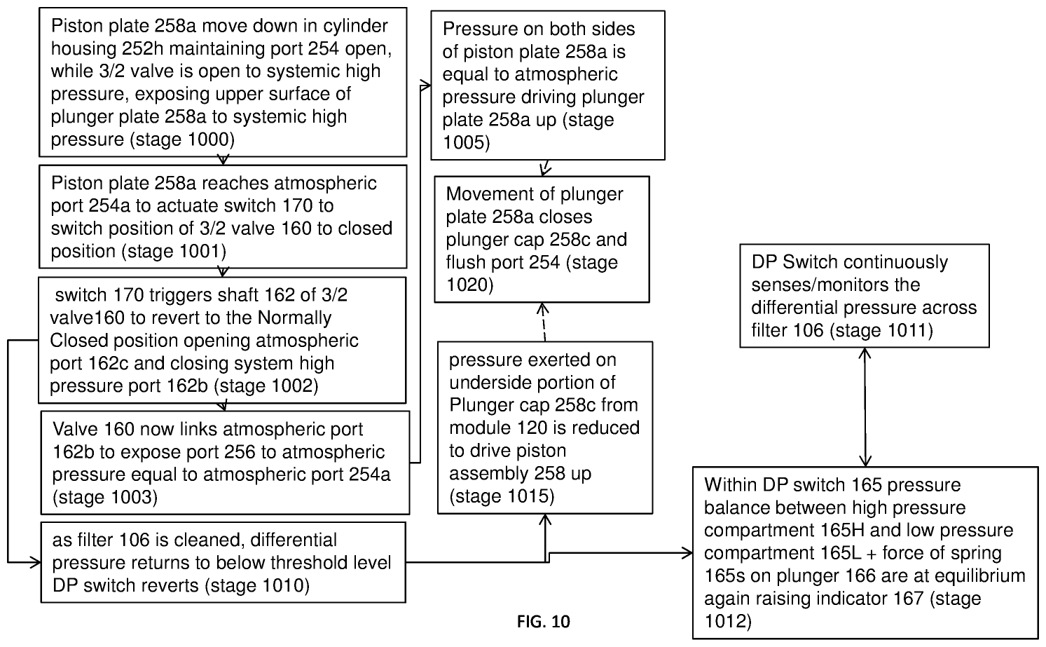

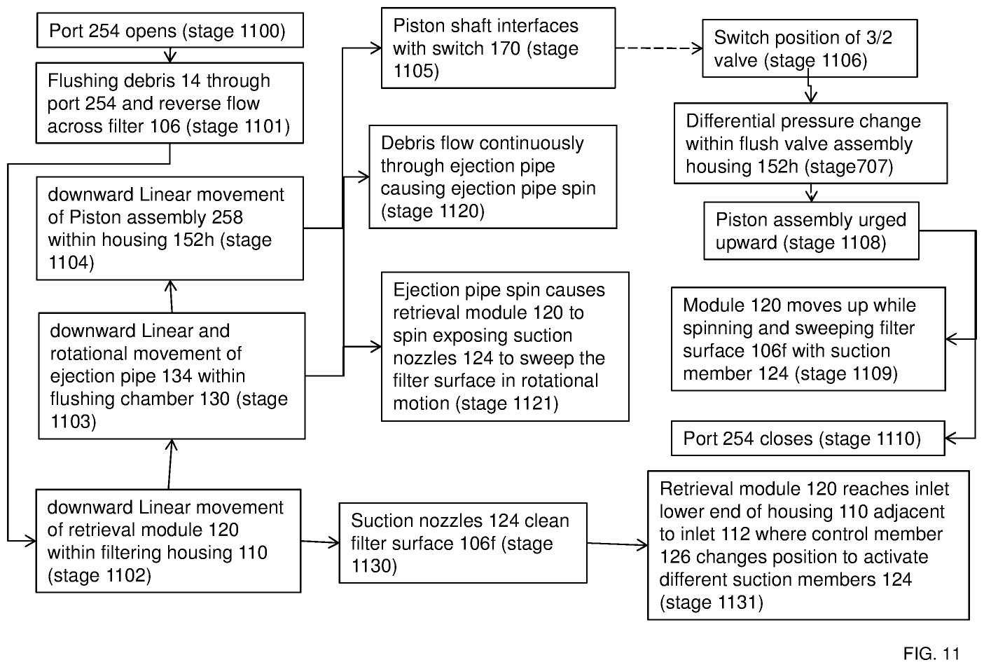

FIG. 8A-B show a further optional depiction of the present invention that utilizes an optional flush valve assembly 252 where the linear movement (up and down) of the flush valve assembly 152 depicted in FIG. 1-4 are reversed. FIG. 9-11 show flowcharts (analogous to those shown in FIG. 5-7) that depict the movement provided with the use of flush assembly 252 of FIG. 8A-B.

FIG. 1A-B show schematic illustrative diagrams of a self-cleaning filter apparatuses 100,101 according to an embodiment of the present invention. Filter apparatus 100,101 is an autonomously regulated self-cleaning filter apparatus that does not require external control or an external energy source to change between a filtering phase and a filter cleaning phase. The filter apparatus is shown as a screen filter apparatus utilized to filter a fluid, for example including but not limited to water.

In embodiments, the self-cleaning filter apparatus 100,101 of the present invention may be used as a stand-alone filtering apparatus or as part of a network of filtering devices including two or more self-cleaning filter apparatuses 100,101 that are in fluid communication with one another therein forming a network.

The filter apparatus 100,101 according to the present invention provides self-cleaning at a threshold differential pressure, for example from about 0.3 to 0.7 atmospheres. That is, when the differential pressure is below the set threshold pressure, the filter apparatus is in the filtering phase, while a differential pressure that is above the threshold pressure initiates the cleaning phase.

The threshold differential pressure may be controllable and/or adjustable by a user for any reason and/or need, or according to at least one or more parameter for example including but not limited to filter application requirement, filter application type, frequency of filtration, water quality, the like or any combination thereof.

The filter apparatus 100,101 according to embodiments of the present invention is characterized in that the transition between the filtering phase and cleaning phase is autonomously controlled without the requirement of external input, human or machine, or external energy, or external manipulation of valves. Therein the filter apparatus 100,101 is preferably self-controlled and regulated.

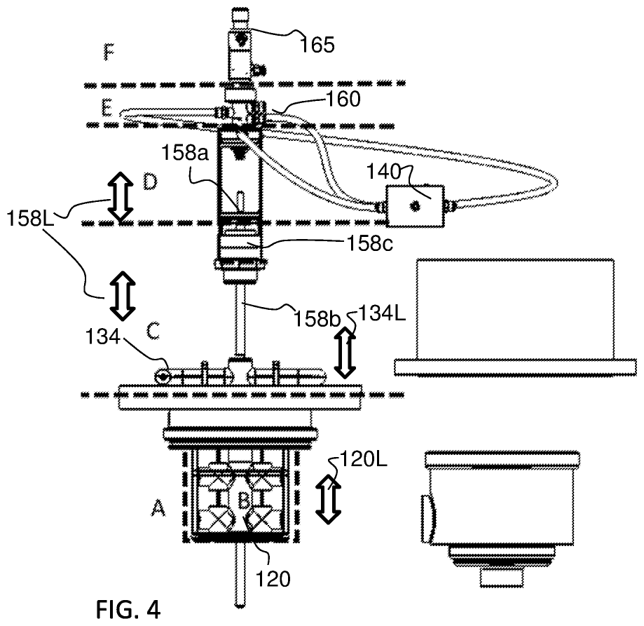

The autonomous driving force for the transition between the filtering and cleaning phases is provided by channeling of differential pressure established across different portions of the filter apparatus 100,101 during the filtering phase, so as to generate sufficient differential pressure flux across different zones and/or portions within the filter apparatus, as will be discussed in greater detail with reference to FIG. 4.

Preferably the differential pressures flux is the driving force that provides for setting in motion a cascade of activity along the filter apparatus as a whole to drive the transition between the filtering and cleaning phases of apparatus 100, 101.

Filter apparatus 100, 101, FIG. 1A-B, includes a filtering housing 110 for filtering a fluid 10 across a screen filter 106, a flushing chamber 130 for housing filtered debris prior to its removal, and a control assembly 150 for controlling the transition between the different filter phases. Most preferably the control assembly 150 provides for channeling the differential pressure along the different portions of the filter apparatus.

Filter apparatus 101, shown in FIG. 1B, is filter apparatus 100, as depicted in FIG. 1A, that is further fit with a three position hydraulic valve relay 140 that is in fluid communication by way of piping with a portion of filter apparatus 100 particularly control assembly 150, as shown. Preferably, the three position hydraulic valve relay 140 is configured and provided in the form of a normally open hydraulic valve three position relay. Valve relay 140 is provided as a failsafe measure to facilitate the operation of control assembly 150 facilitating a smooth transition between filtering phase and cleaning phase and vice versa.

For the purpose of ease of understanding of embodiments of the present invention, the operation of filter apparatus 100,101 will be described in the two modes and/or phases namely, the filtering phase and cleaning phase.

### Filtering Phase

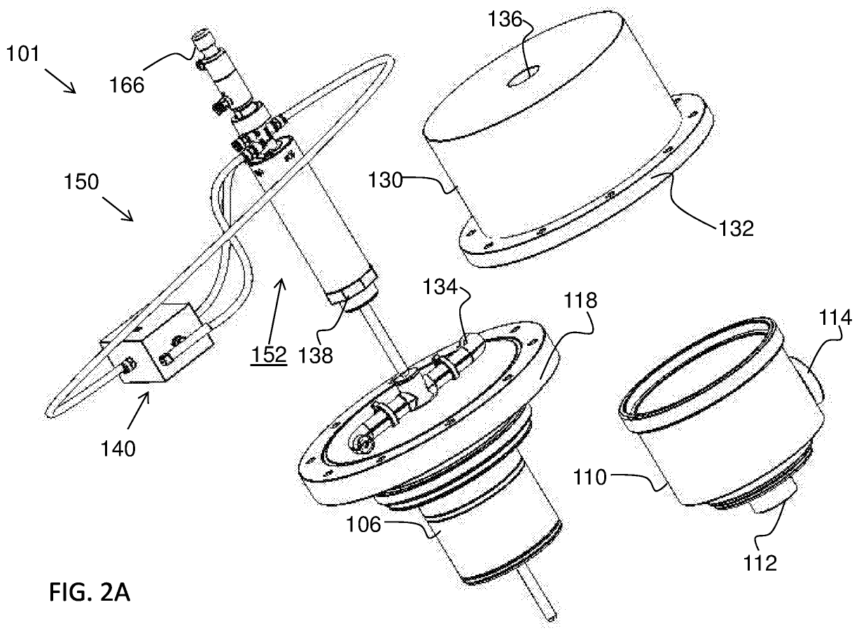

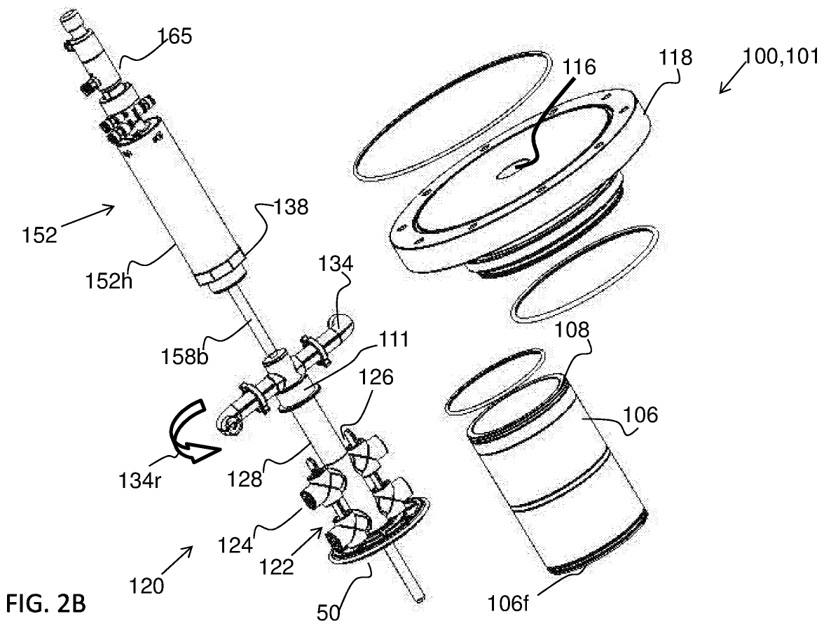

During the filtering phase a raw unfiltered flowing fluid 10, for example including but not limited to water, flows into filtering housing 110 via an inlet 112 and across a filter member 106, FIG. 2A-B, disposed internal to filtering housing 110, therein forming filtered fluid 12 that flows out of filtering housing 110 through outlet 114, while the filtered debris 14, extracted from raw fluid 10, is trapped and/or accumulated along a filtering surface 106f and/or volume of filter 106.

The filtering phase continues until such as time as the differential pressure across the filter 106 and in particular the filtering surface 106f reaches a preset differential pressure threshold pressure, for example between 0.3 bar and 0.7 bar.

### Cleaning Phase

During cleaning phase, also referred to as the flushing phase, the accumulated debris 14 is evacuated and/or flushed from filtering housing 110, through flush port 154 as shown with black arrow 14, FIG. 1A.

In order to switch from filtering phase to the cleaning phase and/or flushing phase the control assembly 150 must provide for opening the flush port 154 so as to allow debris 14 to be flushed from filter apparatus 100,101. The control assembly 150 provides for opening flush port 154 once the proper conditions, differential pressure flux within the control assembly, are met so as to allow apparatus 100,101 to autonomously open the flush port 154. Preferably autonomous opening and closing of flush port 154 is provided by control assembly 150 by channeling the differential pressure flux within the filter apparatus as will be described in greater detail below with respect to the operations of the control assembly.

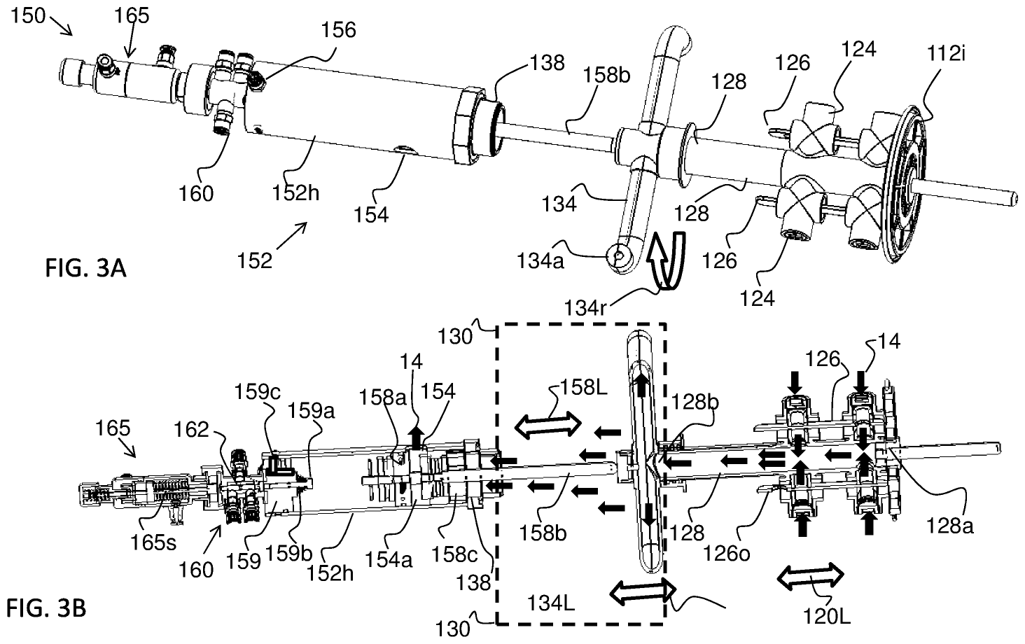

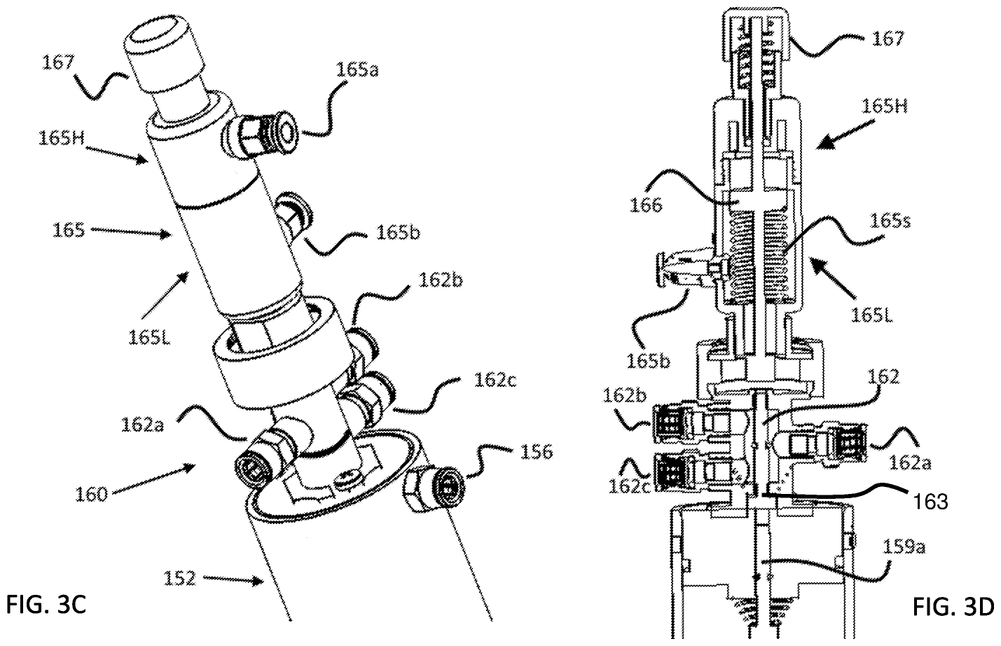

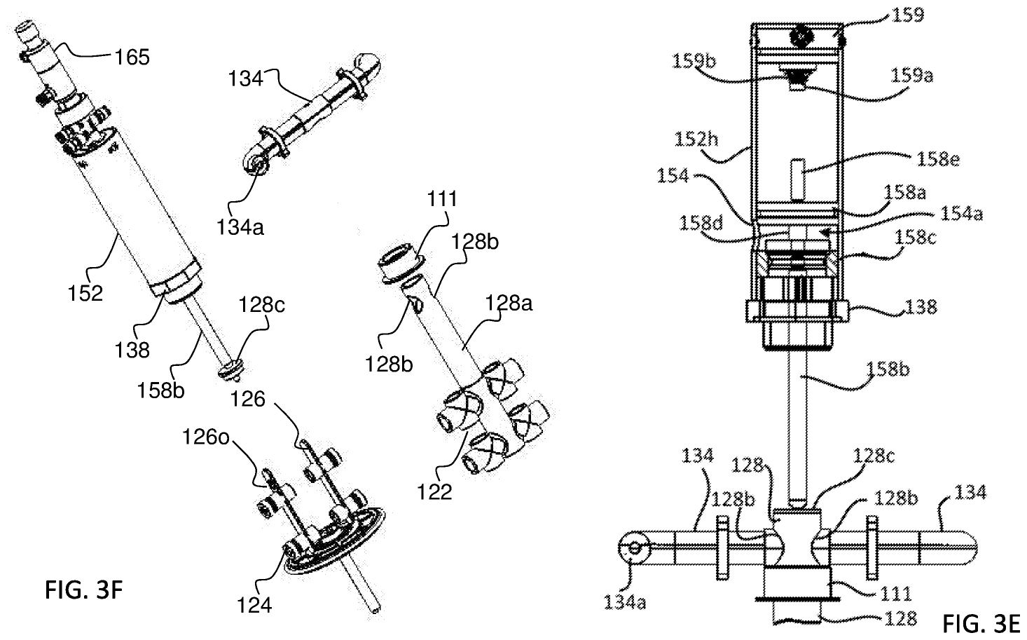

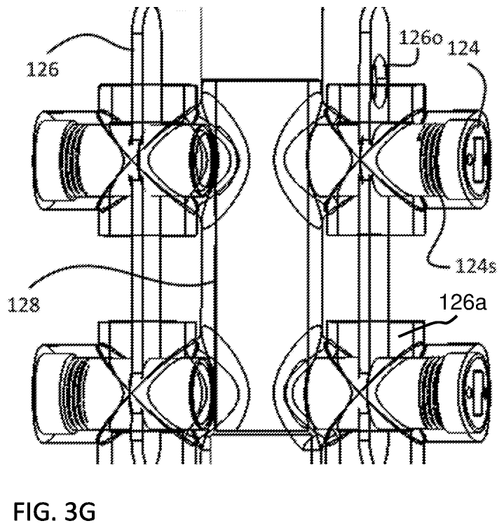

Fluid flow during cleaning phase is described below. During the cleaning phase debris 14, is removed from filter 106 and is allowed to flow via a pipe network out of filter apparatus via flush port 154. The flow of debris 14 during cleaning phase is best seen in FIG. 3B where black arrows represent flow of debris 14 from the filter 106 through a debris retrieving module 120 that includes at least one or more nozzle members 124 and eventually up through filter apparatus 100,101 and out of flush port 154.

FIG. 2-3 show a pipe network in the form of retrieving module 120 that allows debris 14 to flow away from filter member 106 and eventually out through exit port 154, FIG. 3B, includes: a retrieving module 120—that provided for retrieving debris from the filter surface 106f-connected to an ejection pipe 134 disposed within debris flushing chamber 130, where debris removed from filter 106 accumulates prior to being flushed through exit port 154, once flush port 154 is opened with control assembly 150.

Debris retrieving module 120 comprises a debris suction module 122 that is in fluid communication with a debris retrieving pipe 128. The debris suction module 122 features at least one or more nozzle members 124. Nozzle member 124 provide for cleaning the filtering surface 106f from debris 14, by sweeping the filtering surface 106f allowing nozzle member 124 to collect debris 14 as it dislodges from filtering surface 106f due to fluid backflow during the cleaning phase.

Nozzle members 124, shown in FIG. 3F and FIG. 3G, facilitate the flow of debris 14 away from filter surface 106f, by way of allowing a backflow of water across filter 106. Backflow occurs during the cleaning phase where the direction of flow is reversed and water flows in the opposite of the direction of flow during filtering phase. Backflow provides for dislodging debris 14 from filter surface 106f of screen 106 and into nozzle members 124.

More preferably debris suction module 122 includes and/or houses a plurality of suction nozzle members 124.

In embodiments, the number of nozzle members 124 utilized and/or employed at any one point in time may be determined based different parameters and/or based on the filtering application for which its use is intended.

In embodiments, the number of nozzle members 124 utilized and/or employed may be determined based on at least one dimension of the filtering member 106, for example including but not limited to length, radius, volume, surface area, circumference, screen filter pore size, filtering direction (in vs out) the like or any combination thereof.

In embodiments, the number of nozzle members 124 utilized and/or employed may be determined based on water quality and/or the length of filtering member.

In embodiments, the number of nozzle members 124 utilized and/or employed may be determined based on the type of filter 106 utilized.

In embodiments debris suction module 122 may further comprise at least one or more nozzle controlling member 126 that are associated with nozzle members 124 and provided for controlling the flow through nozzle member 124. In particular nozzle control member 126 provides for depicting which nozzle member 124 is active as will be described in greater detail below, with respect to FIG. 3G.

Suction nozzles 124 are coupled to and are in fluid communication with debris retrieving pipe 128, as shown. Debris retrieving pipe 128 is provided in the form of a pipe assembly configured to receive debris flow 14 from nozzle members 124 into the inner volume (lumen) of retrieving pipe 128. Debris receiving pipe 128 comprises a first portion 128a, that is in fluid communication with at least one suction nozzle member 124, and a flow recess 128b that is in fluid communication with ejection pipe 134 disposed within flushing chamber 130. Therefore during the cleaning phase utilizing fluid backflow retrieval pipe 128 provides for allowing debris 14 to flow from filter surface 106f disposed in filtering housing 110 and into flushing chamber 130, via pipe 128, and eventually out filter apparatus via flush port 154, for example as shown by the black arrows representing debris flow 14 in FIG. 3B.

During cleaning phase retrieval module 120 and suction module 122 are configured to both rotate (120R) and move linearly up and down (120L) so as to clean the entire surface of filter 106 and to further control which suction nozzle 124 is activated. The factors causing the movement of retrieval module and suction module will be discussed later with respect to the control assembly 150 and the control of pressure throughout the filter apparatus.

Now referring to FIG. 3F showing a partial exploded view of apparatus 100 and in particular the retrieving module 120 and FIG. 3G showing a close up view of retrieving module 120 and suction module 122, both utilized to clean filtering surface of filter 106. Suction module 122 may be disposed internal to the filter 106 so as to bring nozzles 124 in contact with and/or as close as possible to the filter surface 106f that is to be cleaned.

Optionally and preferably the end of nozzle 124 may be fit with a nozzle spring 124s so as to facilitate close proximity to filter 106 along filter surface 106f, for example as shown in FIG. 3G.

Optionally nozzle spring 124s may further provides to ensure the smooth operation and movement of nozzle 124 along filter surface 106s and to prevent leaking from nozzle 124.

Nozzle spring 124s further facilitates lateral (back and forth) motion of nozzle controlling member 126 associated therewith, preferably so that larger debris does not jam the nozzle controlling member 126 during its up and down movement.

In embodiments control of which of a plurality of suction nozzles 124 is active in cleaning filter surface 106f is provided with a nozzle control member 126 and by way of utilizing the linear movement 120L within filtering housing 110.

Nozzle controlling member 126 is disposed through a portion of suction nozzle 124 intercepting the nozzles flow path, therein providing it with control to block or open the flow path across nozzle 124 into the lumen of retrieving pipe 128 via end 128a. Control member 126 may be configured to control the degree and/or level of flow across flow path of nozzle 124 in a binary (on/off) manner and/or in a continuous manner.

Preferably control member 126 is provided within a housing 126a, FIG. 3G, along suction module 122 such that the control member 126 may intercept or allow the flow across nozzle 124 and into the lumen of pipe 128, therein garnering controlling nozzle 124.

Nozzle controlling member 126 preferably comprises at least one recess opening 126o, wherein the recess 126o is configured to align with the flow pathway of the suction nozzle 124, therein allowing fluid to flow therethrough and in so doing activating the suction nozzle, when the opening 126o and the nozzle flow pathway are in alignment, as best seen in FIG. 3G.

Controlling member 126 is also provided with a portion that blocks/prevents, either fully or partially, fluid flow through the nozzle member 124, by obstruction/intercepting the flow path through suction nozzle 124. Therefore, as module 122 moves in the linear direction 120L, an end of control member 126 comes into contact with a rigid surface to push the member up or down, depending on the direction of linear motion 120L. Once control member 126 moves it changes the alignment between flow path of nozzle 124 and opening 126o. For example, when module 120 is moving upward toward flushing chamber 130, an upper end of control member 126 meets with sealing plate 118 causing control member 126 to depress downward relative to nozzle member 124. This downward motion opens the flow path for some nozzle members 124, by aligning with recess 126o, and closes for other nozzle members 124 by blocking its flow-path. Preferably recess 126o is provided to have a diameter substantially equal to the diameter of the flow path of nozzle 124.

Control of suction nozzle member 124 with control member 126 may be utilized to control the timing and sweep pattern utilized to clean filter 106. Preferably control member 126 provides for the activation control of the on/off status of the at least one or more suction nozzle members 124. Controlling member 126 may be provided to be sensitive and/or responsive to the movement of suction module 122, wherein linear motion 120L and/or its rotational movement of suction module 122 about the axis formed by retrieval pipe 128 may be utilized to open and or close individual suction nozzle members 124.

Optionally control member 126 and nozzle spring 124s may work together to further facilitates lateral (back and forth) motion of nozzle 124 and opening 126o to facilitate debris flow 14 along nozzle 124 pathway to pipe 128 and to ensure that larger debris does not jam along the nozzle pathway.

Optionally nozzle spring 124s further facilitates lateral (back and forth) motion of nozzle of controlling member 126 associated therewith, preferably so that larger debris does not jam nozzle controlling member 126 during it's up and down movement.

In embodiments, suction module 122 may comprise a plurality of nozzle controlling members 126.

In embodiments, nozzle controlling member 126 may be disposed at an end of the suction nozzle 124.

In embodiments, activation member 126 may be configured to have a plurality of activation recess openings 126o corresponding to the number of suction nozzles 124 being controlled, with the individual activation member. In embodiments, activation member recess openings 126o may be configured to be of variable sizes, diameter, so as to control the degree of flow through the nozzle flow path.

In embodiments, nozzle controlling member 126 may be associated with the debris suction module 122 having a plurality of nozzles 124 such the linear position or rotational position of that suction module 122 determines which nozzle 124 is activated.

Optionally the rotational movement of debris removal pipe 134 and in turn the rotational movement of suction module 122, as previously described, may further provide for controlling the on/off status of the at least one suction nozzle 124 by utilizing at least one or more control member 126. In embodiments, a cleaning module 120 and/or suction module 122 may be provided with a plurality of suction nozzles 124 and at least one or more controlling members 126, for example as shown.

In embodiments, such a cleaning module and/or suction module may be configured such that each suction nozzle 124 may be provided with an individual control member 126. Optionally at least two suction nozzles 124 may be provided with a common control member 126. Optionally a group of suction nozzles 124 of the plurality of suction nozzles may be controlled with a common control member 126. The cleaning module may therefore be configured to have a plurality of control members 126 each provided for controlling a sub-group of suction nozzles 124. In embodiments, each suction nozzle 124 may be controlled with at least two control members 126. In embodiments each nozzle flow path may be controlled with at least two control members 126.

In embodiments, the direction of flow across the filtering member 106 may be configured to be outside in, wherein an outer surface of the filtering member 106 is configured to be the active filter surface 106f, and wherein the suction module 122 may be disposed along an external surface of filter 106 wherein at least one suction nozzle 124 of the suction module 122 provides for sweeping an external active filter surface 106f.

Filtering housing 110 and flushing chamber 130 are coupled and sealed from one another with a sealing plate 118 that features a passageway 116, as best seen in FIG. 1A-2B.

Preferably, flushing chamber 130 features a lower surface 132 that provides for securely affixing chamber 130 with sealing plate 118 that is securely coupled to and affixed with filtering housing 110.

Preferably passageway 116 provides for interfacing filtering housing 110 and flushing chamber 130 with an interface member 111, wherein interface member 111 fits within passageway 116 and allows at least a portion of debris retrieving module 120 to access flushing chamber 130, therein allowing debris 14 to flow away from filter 106 and into chamber 130 via flow recess 128b of retrieval pipe 128. Optionally interface member 111 is provided in the form of a seal.

Retrieving pipe 128 is partially disposed within filtering housing 110 and flushing chamber 130 and therefore transcends both housings by extending across plate 118 via passageway 116 through an interface member 111. Retrieval pipe flow recess 128b provides for coupling with ejection pipe 134 so as to form a continuously fluid flow path that allow debris 14 to flow from the internal volume of pipe assembly 128 into ejection pipe 134. Therein flow recess/opening 128b is configured to be disposed within at least a portion of flushing chamber 130, specifically by way of coupling and fluid communication with debris ejection pipe 134. Optionally and preferably pipe assembly 128 is fit with at least two or more flow openings 128b that are directly associated and in fluid communication with ejection pipe 134.

Pipe assembly 128 is sealed with a cap member 128c, FIG. 3F-3G, within flushing chamber 130 so as to ensure that debris 14 flows only through opening 128b into ejection pipe 134 and onto ejection pipe end 134a causing ejection pipe 134 to rotate as shown by arrow 134r, as shown FIG. 2B, FIG. 3A.

Optionally pipe assembly 128 may be provided from at least two or more of pipe segments that are in fluid communication with one another, and provide for debris 14 to flow nozzle members 124 to ejection pipe 134 and into the volume of flushing chamber 130.

Flushing chamber 130 comprises a debris ejection pipe 134 that is in fluid communication with retrieving pipe 128. Ejection pipe 134 is provided in the form of a rotating sprinkler having an ejection end 134a, as shown. Due to the sigmoidal shape and/or rotating sprinkler shape of ejection pipe 134 flow through ejection pipe 134 is jetted out through ejection pipe end 134a causing ejection pipe 134 to rotate as shown by directional arrow 134r, FIG. 2B, 3A. Therein flow of debris 14 through ejection pipe 134 is jetted out through ends 134a and into the volume of flushing chamber 130.

Flushing chamber 130 provides a holding chamber having an open volume for holding debris 14 received from ejection pipe 134 via pipe 128 prior to being flushed out from filter apparatus 100,101 through flush valve exit port 154.

During debris flushing of the cleaning phase, debris 14 flows from open volume of flushing chamber 130 toward port 154 that has been opened by control assembly 150. Once flush port 154 is opened, debris 14 flows from flushing chamber 130 into flush valve assembly 152 and out through port 154. Flush valve assembly 152 is coupled with and in fluid communication with flushing chamber 130 over debris removal opening 136 disposed along the upper surface of flushing chamber 130, for example as shown in FIG. 2A. Therefore, debris 14 flows from chamber 130 through opening 136 and out of port 154.

Opening 136 provides a flow channel between chamber 130 and flush valve assembly 152 so as to allow debris 14 to flow therethrough. Optionally opening 136 may be fit with a mediating member 138 to facilitate coupling flush valve assembly 152 to flushing chamber 130 and to provide a flow channel with flush valve assembly 152.

### Control Assembly

As discussed above control assembly 150 provides for autonomously switching between the filtering phase and cleaning phase of the filter apparatus. Control assembly 150 includes a flush valve assembly 152, a three position two way (3/2) valve 160 and a differential pressure (DP) switch 165, as shown in FIG. 3A-D.

In some embodiments, the control assembly 150 of filter apparatus 101 further comprises a three position hydraulic valve relay 140, FIG. 1B, that is in fluid communication with portions of control assembly 150, most preferably flush valve assembly 152 and three position two way (3/2) valve 160.

Preferably three position hydraulic valve relay 140 is a backup and/or failsafe measure to facilitate control of 3/2 valve 160. Valve relay 140 is provided as a failsafe measure to facilitate the operation of control assembly 150 facilitating a smooth transition between filtering phase and cleaning phase. In so doing the operation of valve relay 140 facilitates the transition between the upward linear movement 158L of piston assembly 158 to open flush port 154, and the downward linear movement 158L of piston assembly 158 to close flush port 154.

Control assembly 150 provides for transitioning between filtering phase and the cleaning phase and vice versa. Preferably this is accomplished by controlling the linear movement 158L of piston assembly 158. Control is provided by establishing and channeling a differential pressure flux across different portion of the filter assembly and in particular portions of control assembly 150. Differential pressure flux is controlled in a closed loop manner across six zones along the filter assembly, as shown in FIG. 4 and labelled zones A-F, and provided below:

Zone A: establishes systemic low pressure of apparatus 100,101, for example along outlet side 114 of filter 106; Zone B: establishes systemic high pressure of apparatus 100,101, for example inlet side 112 of filter 106;

Zone C: dynamic pressure zone, for example retrieving pipe cap 128c; Zone D: dynamic pressure zone, for example flush valve piston plate 158a, 158c;

Zone E: pressure conveying and switching zone, includes 3/2 valve 160 and optionally in combination with valve relay 140;

Zone F: pressure sensing zone, includes DP switch 165;

Accordingly control assembly 150 provides for channeling the differential pressure established across filter 106, zones A-B, to create a differential pressure flux throughout control assembly 150 so as to autonomously control the status of flush port 154. This is accomplished by enabling the conversion of the applied dynamic differential pressure flux to mechanical forces applied onto portions of the control assembly and in particular flush valve assembly 152 control the linear movement of a piston assembly 158 so as to open or close the flush port 154.

### DP Switch 165

DP switch 165, best shown in FIG. 3C-3D, is configured to be sensitive to the filter apparatus's 100,101 desired differential pressure threshold such that it is configured to switch at the threshold level. DP switch 165 includes two compartments a high pressure compartment 165H along an upper portion and a low pressure compartment 165L along a lower portion. DP switch 165 includes a plunger 166 disposed between the two compartments such that it is sensitive to pressure applied by each of the two compartments. Plunger 166 is capable of moving up toward the high pressure side 165H or down toward the low pressure side 165, depending on where more pressure is exerted.

High pressure compartment 165H is fit with a port 165a that is in fluid communication with systemic high pressure, for example from Zone B. Therein high pressure compartment 165H is sensitive to the systemic high pressure environment. High pressure compartment 165H is set to exert a force along the upper portion of plunger 166, urging plunger 166 downward.

Low pressure compartment 165L is fit with a port 165b that is in fluid communication with systemic low pressure defined by Zone A. Therein low pressure compartment 165L senses the systemic low pressure environment.

Compartment 165L is further fit with a biasing spring 165s that provides for determining the differential pressure threshold of filter apparatus 100,101. Low pressure compartment 165L and biasing spring 165s exert a collective force along the lower portion of plunger 166 urging plunger 166 upwards.

Most preferably plunger 166 remains at steady state and/or equilibrium so long as the differential pressure across plunger 166 is below the filter's preset threshold pressure, therein during filtering phase DP switch is in equilibrium.

DP switch 165 is configured such that once the differential pressure across plunger 166 is above the threshold differential pressure, plunger 166 depresses toward the low pressure compartment 165L, resulting in a first step of a cascade of action to switch from filtering phase to cleaning phase/flushing phase.

Preferably the lower end of plunger 166 is contiguous with but not coupled nor affixed with 3/2 control shaft 162 of 3/2 valve 160, for example as shown in FIG. 3D. Therein plunger 166 provides for changing the status of 3/2 valve 160 form its normally open position to a closed position, when the differential pressure is crossed (upwards).

Optionally the differential pressure threshold level, defined by spring 165s, may be adjusted by controlling at least one or more parameters associated with DP switch 165. Optionally threshold level may be adjusted and/or controlled by setting the tolerance of spring 165s. Accordingly the threshold differential pressure for initiating the self-cleaning may be selected per application of the apparatus 100,101 of the present invention by selecting the appropriate differential pressure spring 165s utilized in DP switch 165. Optionally the DP threshold may be manually adjustable by manually adjusting the tolerance of spring 165s so as to produce the necessary spring tension to control the self-cleaning phase differential pressure threshold.

### 3/2 Valve 160

Most preferably valve 160 is contiguous with but not coupled with DP switch 165, along an upper portion of valve 160 and contiguous with flush valve assembly 152 along a lower portion of valve 160. Valve 160 provides a pressure conveying and/or switching means while it is internally not directly affected by the dynamic pressure along apparatus 100,101 instead it provides for relaying and/or conveying and/or communicating the changing pressure state to flush valve assembly 152.

Three way two position (3/2) valve 160 is preferably disposed between flush valve assembly 152 and differential pressure switch 165, as shown. Therein valve 160 provides for transmitting and/or communicating pressure between DP switch 165 and flush valve assembly 152, as best seen in FIG. 3C-3D.

Most preferably valve 160 is a normally open (N.O.) 3/2 valve, such that during filtering phase the 3/2 valve 160 is closed to atmospheric pressure (exhaust) and bridges between flush valve assembly 152 and DP switch 165. Accordingly, valve 160 provides for maintaining and/or establishing the necessary differential pressure across piston plate 158a disposed in flush valve assembly 152 relative to exit port 154 therein facilitating control of the open/close status of the exit port 154.

Three way two position (3/2) valve 160 comprises three ports (ways) an outlet port 162a and two inlet ports 162b and 162c. Port 162a provides an outlet port that is in fluid communication with flush valve assembly 152 via port 156. Port 162b is a port that receives and is sensitive to the filter apparatus's systemic high pressure, therein it is in fluid communication with a high pressure zone for example including but not limited to inlet 112. Port 162c is an exhaust port that is open to atmospheric pressure. Therefore 3/2 valve 160 provides a valve capable switching between the three ports (ways) to provide two positions and or fluid connections, namely, between port 162a and one of port 162b or 162c.

Switching between the two positions of 3/2 valve 160 is provided by a control shaft and/or plunger 162. The position of plunger 162 is determined by the force applied on either end of plunger 162, upper side from DP switch 165 and on lower side by flush valve assembly 152. The upper end of plunger 162 is contiguously associated with but not affixed with DP Switch plunger shaft 166. The lower end of plunger 162 is contiguously associated with but not affixed with flush valve cap shaft 159a of valve assembly 152, as can be seen in FIG. 3D. Valve 160 is therefore in fluid communication with valve assembly 152 via connected ports 162a and 156, so as to convey either systemic high pressure via port 162b or atmospheric pressure 162c. This connection provides for controlling the pressure applied along the upper portion of valve assembly plunger 158a, wherein the position of 3/2 valve 160 depicts if the pressure level exerted along upper portion of valve assembly plunger 158a is systemic high pressure via port 162b or atmospheric pressure via port 162c.

Most preferably 3/2 valve 160 is configured to be normally open such that during the filtering phase port 162a is in fluid communication with port 162b and during cleaning phase port 162a is in fluid communication with port 162c and therefore open and/or exposed to atmospheric pressure.

During the filtering phase the normally open valve 160 facilitates the control assembly 150 in maintaining flush exit port 154 closed. During the cleaning phase 3/2 valve 160 establishes a flow path between flush valve assembly 152 and atmosphere port of valve 160 so as to alter the differential pressure across piston plate 158a to facilitate opening flush port 154.

In embodiments, filter apparatus 100 may be further fit with valve relay 140 to form apparatus 101, as shown in FIG. 1B. Valve relay 140 is provided as a failsafe measure to facilitate the operation of control assembly 150 facilitating a smooth transition between two linear movements, up and down (158L) of piston assembly 158, and therefore the smooth transition between filtering phase and cleaning phase. Three position hydraulic valve relay 140 is configured and provided in the form of a normally open, three position hydraulic relay disposed between port 162a of 3/2 valve 160 and port 156 of flush valve assembly 152 and further connected to exhaust port 162c. Accordingly hydraulic valve relay 140 provides a failsafe measure to facilitate 3/2 valve 160 movement of shaft 162 to ensure that its upward movement is complete to close port 162c. This failsafe measure is provided in particular during the switch from cleaning phase back to filtering phase therein indirectly facilitating closure of flush port 154.

Flush Valve Assembly 152

Flush valve assembly 152, best seen in FIG. 3C-F, is associated with 3/2 valve 160 along the upper portion of valve assembly 152 and with flush chamber 130 along the lower portion of assembly 152.

Flush valve assembly 152 comprises a housing 152h having a defined volume that is encapsulated along its upper portion by a flush valve housing cap 159, a flush valve exit port 154 along the perimeter of housing 152h, a port 156, and flush valve piston assembly 158 internal to housing 152h.

Flush valve assembly 152 provides for opening and closing exit port 154 with flush valve piston assembly 158 based on the differential pressure flux applied across a piston plate 158a, 158c of piston assembly 158.

Flush valve assembly housing 152h has a defined volume. Optionally the volume and/or dimensions of housing 152h may be controlled and/or selected based on at least one or more filtering parameters for example including but not limited to the filter application type, differential pressure threshold, length of filtering phase, length of cleaning phase, water quality, water pressure, the like or any combination thereof. Optionally the volume of housing 152h may be defined based on the size of at least one or more portion of the filter apparatus for example including but not limited to the volume/height of flushing chamber 130, filter size, filtering housing volume and/or length, the like or any combination thereof.

Housing 152h may take any shape and is not limited to the cylindrical shape depicted in the drawings herein.

The lower end of housing 152h is in fluid communication with flushing chamber 130 via opening 136 and a mediating member 138 disposed thereof. Mediating member 138 may for example be realized in the form of a coupling nut connecting the lower end of housing 152h with flushing chamber 130 over opening 136.

The upper end of housing 152h is disposed adjacent to 3/2 valve 160 and is fit with a cap 159, as shown in FIG. 3A-F.

Cap 159 provides a physical barrier to seal housing 152h and further provides a stage for aligning and associating with 3/2 valve 160, along the upper surface of cap 159.

FIG. 3B and FIG. 3E show cap 159 that preferably comprises a central recess for receiving a cap shaft 159a. Shaft 159a provides for aligning and interfacing with shaft 162 of 3/2 valve 160. Accordingly shaft 159a facilitates switching the state of 3/2 valve 160. Most preferably shaft 159a urges shaft 162 so as to bring 3/2 valve 160 back to its normally open position, as discussed above, in so doing facilitating the closure of flush port 154 after the cleaning phase.

Shaft 159a is optionally and preferably fit with a spring 159b along a lower portion thereof, for example as shown. Spring 159b facilitates movement of shaft 159a and further provides for applying a downward force on a portion piston assembly 158 preferably along the upper portion of piston shaft assembly 158b, more preferably along shaft portion 158e.

Cap 159 features an internal flow channel 159c that defines port 156, as shown in FIG. 3B. Channel 159c forming port 156 allows the upper surface of piston plate 158a to be exposed to a differential pressure flux so as to facilitate control the open/closed status of flush port 154. During the cleaning phase, port 156 provides for exposing the upper surface of piston plate 158a to atmospheric pressure originating from port 162c of 3/2 valve 160. During the filtering phase, port 156 provides for exposing the upper surface of piston plate 158a to systemic high pressure originating from port 162b of 3/2 valve 160.

The external surface of 152h features flush port 154 that is preferably disposed adjacent to lower end of housing 152h. The size (diameter) and/or location of flush port 154 along housing 152h may be controlled and/or placed in any location along housing 152h the in order to control the timing of at least one the filtering phase, cleaning phase, and/or an intermediate transition phase. Optionally the location and/or size (diameter) of flush port 154 may be adapted according to at least one or more filtering parameter for example including but not limited to the filter application type, differential pressure threshold, length of filtering phase, length of cleaning phase, water quality, water pressure, the like or any combination thereof.

Flush port 154 may be opened and closed with piston assembly 158 disposed internal to housing 152h. Piston assembly 158 comprises a piston plate assembly including an upper portion 158a, a lower portion 158c and a piston shaft 158b, 158d, 158e.

Piston plate assembly comprises an upper portion 158a and a lower portion 158c is characterized in that it provides for forming a flush port area 154a adjacent to port 154, that is open to atmospheric pressure while maintaining port 154 closed. Flush port area 154a is formed by sealing the port 154 along an upper edge by piston plate portion 158a and a lower edge with piston plate portion 158c therein forming an exposed and/or open area 154a that is open to atmospheric pressure. Flush port area 154a provides for simultaneously applying atmospheric pressure along the lower surface of piston plate 158a and upper portion of piston plate 158c. In so doing flush port open area 154a contributes to the differential pressure flux such that during filtering phase only flush port area 154a of filter apparatus 100,101 is open and exposed to atmospheric pressure. However, during cleaning phase flush port 154 is opened as lower piston plate 158c moves up to cross area 154a to opening port 154 and exposing flushing chamber 130 to atmospheric pressure.

Optionally piston plate assembly 158a, 158c may be provided from multiple pieces and/or a single unitary part capable of forming area 154a.

Piston plate portion 158a has an upper surface and a lower surface across which differential pressure flux is applied to control the status of flush port 154. As described above lower surface of piston plate portion 158a is exposed to atmospheric pressure. The upper surface of piston plate portion 158a is exposed to the pressure supplied via port 156 and its connection to port 162b of 3/2 valve 160. Accordingly control of the linear position of piston plate portion 158a within housing 152h is determined by the balance of the differential pressure flux applied across the surfaces piston plate portion 158a.

During filtering phase the net differential pressure flux applied on plate 158a is down, to maintain port 154 closed, upper surface exerts a systemic high pressure via ports 156 and 162b, while the lower surface exerts atmospheric pressure from port 154.

During cleaning phase the net differential pressure flux applied on plate 158a is up, to maintain port 154 open, upper surface exerts atmospheric pressure via port 156, 162c and lower surface exerts atmospheric pressure from 154 and upwards mechanical forces provided by shaft 158b,158d,158e, the combination resulting in upward movement of plate 158a.

Piston shaft may be realized as a single shaft member along the length of piston assembly or as shown may be provided from a contiguous network of piston shafts 158b, 158d, and 158e, for example as shown in FIG. 3E. Preferably the plurality of piston shaft portions 158b, 158d, 158e are contiguous with one another forming a continuous piston shaft assembly that is configured to interact with one another in a successive manner.

Piston plate portion 158c has an upper surface and a lower surface across which differential pressure flux is applied to control the status of flush port 154. As described above upper surface of piston plate portion 158c is exposed to atmospheric pressure, from flush port area 154a and the net forces applied on plate portion 158a. The lower surface of piston plate portion 158c is exposed to the pressure of flushing chamber 130.

Accordingly control of the linear position of piston plate portion 158c within housing 152h is determined by the net forces and pressure differential pressure flux applied across the surfaces piston plate portion 158c.

During filtering phase the net differential pressure flux applied on plate 158c is down, to maintain port 154 closed, upper surface is exposed both to atmospheric pressure port 154a and the net forces exerted by plat portion 158a while the lower surface is exposed to the systemic low pressure from flushing chamber 130.

During cleaning phase the net forces acting on plate 158c is up, to open port 154 and maintain it open, upper surface exerts force applied on plate portion 158a which is at atmospheric pressure and lower surface exerts net upwards mechanical forces provided by shaft 158b, 158d, 158e that originates from cap 128c, the combination resulting in upward movement of plate 158c.

Piston shaft portions 158b, 158d, 158e are securely associated with piston plate portions 158a, 158c and used to apply mechanical forces on piston plate 158a, 158c for controlling their linear position within housing 152h.

As shown piston shaft 158b extends into the open volume of flushing chamber 130 and is associated at one end over cap 128c. Preferably cap 128c and the lower end of shaft 158b are associated with one another in a non-fixed and/or rigid manner, FIG. 3F-3G. Preferably the non-rigid association and/or coupling allows for translation of the successive linear motion.

Optionally ejection pipe 134 and/or cap 128c may be fit with an adaptor and/or recess (not shown) for receiving the lower end of piston shaft 158b so as to non-rigidly associate therewith while providing a coupling recess that enables corresponding linear motion, as described.

Control assembly 150 is preferably self-sustaining and does not require external input or power source. It is appreciated that while external input or power source is not required for the normal functioning of filter assembly 100,101, such automation means may be added to embodiments of the present invention. Furthermore control assembly 150 may be controlled manually therein providing a “manual override” via DP switch indicator 167 that provides for initiating the self-cleaning cycle by depressing indicator 167. Similarly filter assembly 100,101 may be fit with an automated means for actuating and/or depressing indicator 167 of DP switch 165 to initiate the self-cleaning cycle.

### Differential Pressure Flux Path

In embodiments transition from filtering phase to cleaning phase and vice versa is provided by autonomously changing the differential pressure flux applied across the filter apparatus along six zones labelled A through F, as shown in FIG. 4.

Filter apparatus 100, 101 provides a filtering apparatus capable of autonomously balancing the state of pressure differential flux between zones A-F and in particular to balancing the dynamic pressure differential between zones A-B-C and D-E-F so as to navigate the differential pressure about piston plate 158a, 158c to provide autonomous control of the status of exit port 154. Most preferably the dynamic differential pressure flow is managed without external input and/or energy. Management of the differential pressure flux between at the different zones is provided by the use of 3/2 valve 160 and optional relay 140.

Zone A includes the outlet side of filter 106 generally defining the systemic low pressure zone.

Zone B generally defining the systemic high pressure, the lower border formed by the inlet side of filter 106, the length of retrieving module 120, and a upper border formed by sealing plate 118.

Zone C encompassing flushing chamber 130 the lower border including the ejection pipe 134, pipe cap 128c and piston shaft 158b and upper border including upper surface of piston plate 158c.

Zone D includes the lower border defined by under surface of piston plate 158a and upper border defined by port 156.

Zone E includes 3/2 valve 160 with its three ports 162a, 162b, 162c in communication with port 156. In some embodiments Zone E may be provided to include valve 160 that is in combination with valve relay 140.

Zone F includes DP switch 165 having a preset DP threshold level defined between a low pressure port 165b, reflective of the systemic low pressure of provided by Zone A, and a high pressure port 165b reflective of the systemic high pressure provided by Zone B.

The differential pressure is progressively generated and evolving on either sides of filter 106 as the filter is clogged, filtering phase, and de-clogged, cleaning phase. The changing differential pressure is communicated and/or circulated around all of the Zones A-F in order to allow filter apparatus 100,101 to autonomously switch between cleaning and filtering phases.

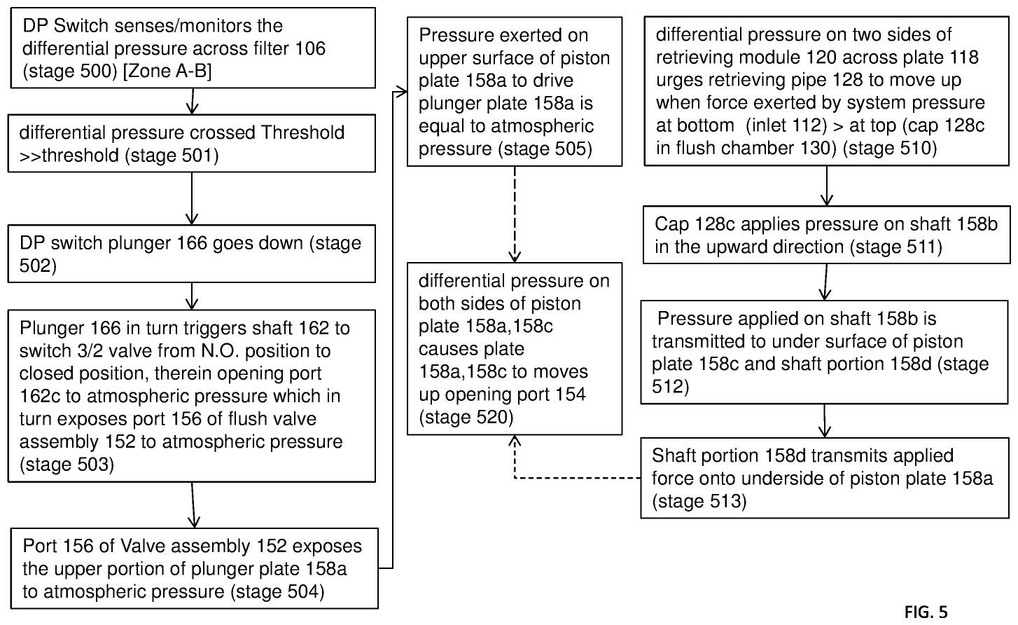

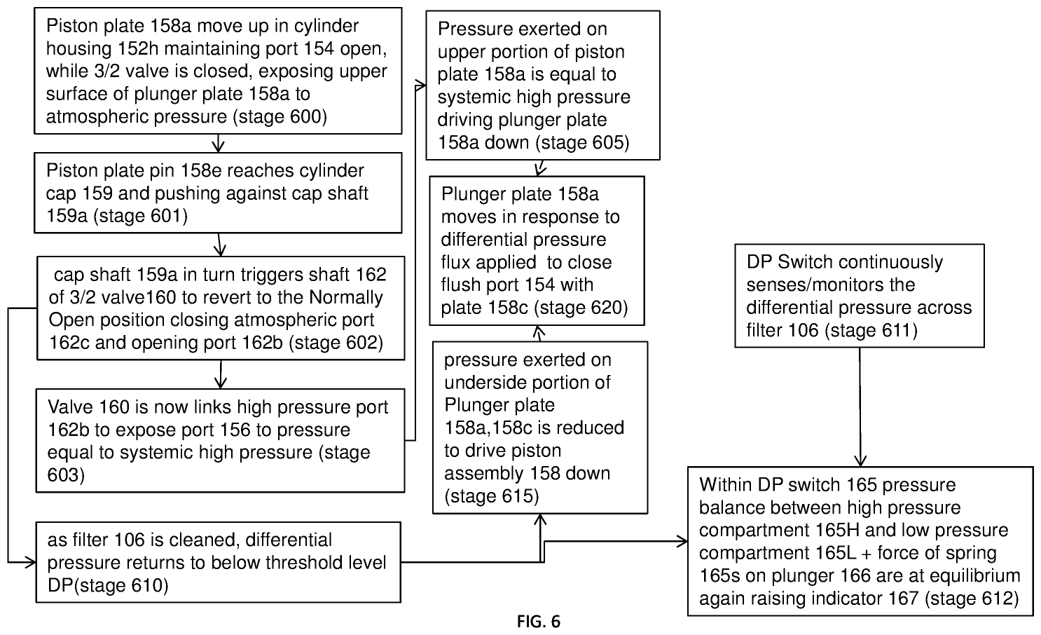

Switching from filtering phase to cleaning phase, is depicted in the flowchart of FIG. 5:
I. Differential pressure build up across filter 106 is defined between zones A-B, Zone A defines the systemic low pressure and Zone B defines the systemic high pressure. Zone A and Zone B are in fluid communicated by way of piping to Zone F to control the position of DP switch 165. Zone A is in communication with low pressure port 165b and Zone B is in communication with high pressure port 165a. Such that DP switch 165 is sensitive to the differential pressure across filter 106, relative to a preset threshold value, that is defined by spring 165s. As depicted in stages 500 to 502.
II. Zone F communicate the differential pressure status to Zone E causing valve 160 to switch from its normally open position to the closed position. Valve 160 now links port 162c, exhibiting atmospheric pressure, to port 162a that is in communication with port 156. Therefore Zone E provides for communicating differential pressure from Zone F to convey atmospheric from Zone E and into Zone D. As depicted in stages 503 to 504.
III. Zone E introduces atmospheric pressure that is applied within Zone D via port 156. Zone D includes a differential pressure sensitive member in the form of piston plate 158a, 158c where the differential pressure is exhibited along its upper portion and lower portion. The upper surface of piston plate 158a now experiences atmospheric pressure from port 156. The under surface of piston plate 158a, experiences atmospheric pressure exhibited from flush port area 154a and closed flush port 154. Port 154 remains closed until additional pressure is applied along the under surface of piston plate 158a via plate 158c from Zone C. As shown in Stages 505 and 520.
IV. Zone C provides the additional pressure required to open flush port 154 due upward pressure applied on underside of plate 158a,158c via at least a portion of piston shaft 158b, 158d, 158e. The upward pressure applied on shaft 158b by cap 128c originates in the differential pressure exhibited across sealing plate 118 between Zones B-C, particularly across the length of retrieving module 120. The force exerted on the inner surface of cap 128c from within the lumen of retrieval pipe 128 causing an upward movement of retrieving module 120. The force is resultant of the systemic high pressure within Zone B exerted on a portion of retrieval module 120 within filtering housing 110 (Zone B) relative to the same pressure that is exerted on a small surface of retrieval module 120, namely the inner surface of cap 128c, within flushing chamber 130 (Zone C). The difference in surface area causes a higher net force upwards acting on the inner surface of cap 128c that leads to the upward linear motion 120L of retrieving module 120. Upward linear motion 120L in turn translates into the upward motion 134L of ejection pipe 134 and upward linear motion 158L of piston shaft 158b. As depicted in stages 510 and 511.
V. The upward force and in turn the upward linear motion 158L of piston shaft 158b applies an upward force along the underside of piston plate 158c, urging it upward to open port 154 to flushing chamber 130. The linear upward force is transmitted to piston shaft portion 158d and thereafter the underside of piston plate 158a. As depicted in stages 512 and 513.
VI. It is appreciated that the activity described in I to III (stages 500 to 505) occur substantially simultaneously and in parallel with the activity described in IV to VI (stages 510 to 513). Therefore the cumulative forces acting on either side of piston plate 158a determine when port 154 is opened, as described in stage 520.
VII. Once flush port 154 is open it exposes flushing chamber 130 to atmospheric pressure via port 154 causing a differential pressure that allows debris 14 to flow out of filter apparatus 100,101 through flush port 154.
VIII. The cleaning phase and flushing of debris 14 continues so long port 154 is open. While port 154 is open the differential pressure about piston plate 158a is such that it allows piston shaft 158b,158d, 158e to continue its upward movement within housing 152h upward toward cap 159. Piston shaft 158e meets with cap shaft 159a leading to the switching of the position of 3/2 valve 160, both leading to the onset of closure of flush port 154, as depicted in FIG. 6.
IX. Flow chart of FIG. 6 depicts the closure of port 154 when switching from cleaning phase to filtering phase. In stages 600-605, changing the position of 3/2 valve 160 shifts valve 160 back to its normally open position where port 156 is in fluid communication with port 162a that is in fluid communication with systemic high pressure port 162b. Therein switching the position of 3/2 valve 160 via port 156 changes the pressure within valve assembly 152 from atmospheric pressure to systemic high pressure. The change in pressure within assembly 152 is channeled and exerted on the upper surface of piston plate 158a applying a downward force on piston plate 152a urging it down within housing 152h. The direction of motion of piston plate 158a is provided by the imbalance of pressure (sum of the pressure and/or forces) as applied along its upper surface and it's under surface. The force applied along the underside of plate 158a originates from the upward pressure applied by piston shaft 158b originating in Zone C. Accordingly as filter 106 is cleaned the pressure applied by piston shaft 158b reduces, allowing plate 158a to move down within housing 152h, eventually closing flush port 154, stage 615. Accordingly, the pressure in 152h as applied along the surface area of the upper surface of plate 158a produces the downward force that causes piston assembly 158 to move down surface area is what causing the down movement 158L.
X. Accordingly as filter 106 is cleaned the forces acting on plunger 166 of DP switch 165 from high pressure compartment 165H are equal to forces exerted from the combination of low pressure compartment 165L and bias spring 165s, as shown in stages 610 to 612.
XI. Flush port 154 is maintained in its open status until piston plate 158c is pushed back down across port 154. During this time filter 106 continues to be cleaned from debris 14 with retrieval module 120, evacuated from using ejection pipe 134 and through the flush port 154, stage 620.

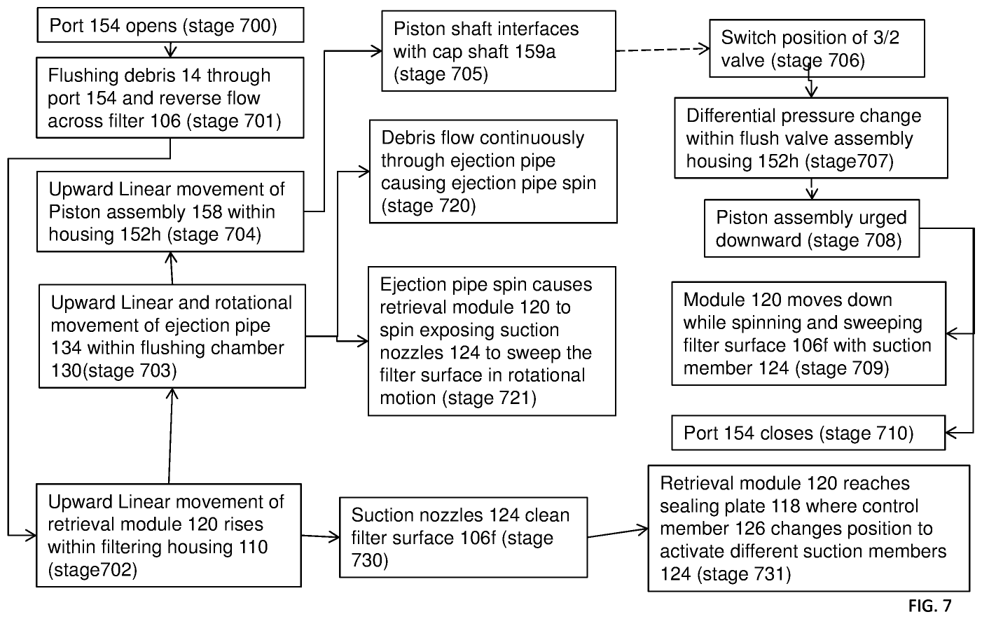

FIG. 7 shows a flow chart that summarizes the overall flow and linear movement through filter assembly 100,101 from the time flush port 154 is open, stage 700, to the time when flush port 154 is closed.

Now referring to FIG. 8A-B showing an optional embodiment of filter assembly 100,101 according to the present invention that employs a flush valve assembly 252. Flush valve assembly 252 may be used with filter assembly 100,101 instead and/or interchangeably with valve assembly 152 as previously described. For the sake of clarity and conciseness only the differences between the flush valve assemblies 152 and 252 are discussed in detail below. The numbering of flush valve assemblies 152 and 252 and their individual components are similarly numbered so as to reflect similarly functioning parts and/or members.

Flush valve assembly 252 may be utilized within control assembly 150 by way of functionally associating with DP switch 165 and three position two way valve 160. In optional embodiments control valve 150 may further comprise relay 140, as previously described. The individual function of DP switch 165, 3/2 valve 160 and relay 140 are not described in detail with respect to its function with flush valve assembly 252.

Flush valve assembly 252 is distinct from flush valve assembly 152 in that the linear movement 158L of its components are configured to be reversed during the different filtering phases. Components of flush valve assembly 152 are configured to move up during the cleaning phase and move down during the transition to the filtering phase, as previously described. Reversibly, similarly functioning parts of assembly 252 are configured to move down during cleaning phase and up during the transition phase back to filtering phase.

Accordingly filter 100,101 fit with flush valve assembly 252 utilize an ejection pipe that is fit at the upper portion of flushing chamber 130, for example as shown.

Flush valve assembly 252 comprises a housing 252h having a generally cylindrical body with a defined volume that is encapsulated along its upper portion with a housing cap 259, an internal dividing plate 252d, and an open lower end that is used to couple housing 252h to flush chamber 130.

The perimeter of housing 252 features a flush port 254 disposed below dividing plate 252d and a port 254a that is exposed to atmospheric pressure and is disposed above dividing plate 252d. Dividing plate 252d provides for channeling debris 14 from flush chamber 130 out through flush port 154 therein preventing debris 14 from entering the upper portion of housing 252h. Preferably dividing plate 252d comprises a central recess for receiving a portion of shaft 258b that provides for forming a guiding axis for shaft 258b so as to allow shaft 258b to move linearly 258L along the length of housing 252h.

Cap 259 features a port 156 provided for connection valve assembly 252 to 3/2 valve 160.

The internal volume of valve assembly 252 features flush valve piston assembly 258. Piston assembly 258 is similar in form and function to the previously described piston assembly 158.

Flush valve assembly 252 provides for opening and closing flush port 154 with flush valve piston assembly 258 based on the differential pressure flux applied across a piston plate 258a of piston assembly 258.

Flush valve assembly housing 252h has a defined volume. Optionally the volume and/or dimensions of housing 252h may be controlled and/or selected based on at least one or more filtering parameters for example including but not limited to the filter application type, differential pressure threshold, length of filtering phase, length of cleaning phase, water quality, water pressure, the like or any combination thereof. Optionally the volume of housing 252h may be defined based on the size of at least one or more portion of the filter apparatus for example including but not limited to the volume/height of flushing chamber 130, filter size, filtering housing volume and/or length, the like or any combination thereof.

Housing 252h may take any shape and is not limited to the cylindrical shape depicted in the drawings herein.

The lower end of housing 252h is in fluid communication with flushing chamber 130 via opening 136 and a mediating member 138 disposed thereof, as previously described. Mediating member 138 may for example be realized in the form of a coupling nut connecting the lower end of housing 252h with flushing chamber 130 over opening 136.

The upper end of housing 152h is disposed adjacent to 3/2 valve 160 and is fit with a cap 259, as shown in FIG. 8A-B.

Cap 259 provides a physical barrier to seal housing 252h and further provides a stage for aligning and associating with 3/2 valve 160, along the upper surface of cap 259, via 256.

Control assembly 150 provides for transitioning between filtering phase and the cleaning phase and vice versa. Preferably this is accomplished by controlling the linear movement 258L of piston assembly 258 which is provided to control the status of flush port 254, open when in self-cleaning phase, as shown in FIG. 8B and closed when in filtering phase, as shown in FIG. 8A.

Piston assembly 258 comprises a piston shaft 258b having an piston plate 258a disposed adjacent to the upper end of shaft 258b and a lower piston plate cap 258c disposed adjacent to the lower end of shaft 158b.

Piston plate cap 258c provides for opening or closing flush port 254 by way of controlling the flow of debris 14 from flush chamber 130 through opening 136. Cap 258c preferably controls the flow of debris 14 by opening or closing opening 136. Accordingly, during the cleaning phase cap 258c moves down opening therefore opening 136 that allow for debris 14 to flow from flush chamber 130 to flush port 254, as shown in FIG. 8B. During filtering phase, as shown in FIG. 8A, cap 258c is in the close position where opening 136 is closed therefor maintaining flush port 254 closed.

Piston plate 258a is disposed within the upper portion of housing 252h above dividing plate 252d as shown. Plate 258a is configured to be reactive and/or sensitive to the changes in differential pressure within the filter housing 110 across filter 106, as previously described.

The lower portion of plate 258a is continuously—during all phases of the filtering cycle—exposed to atmospheric pressure originating from port 254a that is continuously opened to atmospheric pressure.

The upper portion of plate 258a is exposed to pressure provided by port 156 stemming from 2/3 valve 160 port 162a that provides either atmospheric pressure from port 162c, during filtering phase, or high systemic pressure (from zone “B”) via port 162b, during cleaning phase. During filtering the upper portion of piston plate 258a is set to experience atmospheric pressure via port 156 from valve 160; Valve 160 is set to link port 162a with port 162c to generate atmospheric pressure on upper portion of plate 258a. Accordingly during the filtering phase piston plate 258a is stationary as pressure balance is achieved across both sides of plate 258a.

During the cleaning phase the upper portion of plate 258a is set to experience systemic high pressure (form Zone B as previously described) while experiencing atmospheric pressure along the lower portion from port 254a. The resultant pressure imbalance across plate 258a urges plate 258a, shaft 258b and in turn plug 258c to concertedly move linearly down to open flush port 254 allowing debris 14 to escape flush chamber 130 via opening 136. The pressure imbalance is caused with DP switch 165 that switches the position of 2/3 valve 160, as previously described, from atmospheric pressure to systemic high pressure by liking port 162b to port 162a and into port 156. The downward movement of piston assembly 258 further urges debris retrieving pipe 128 and ejection pipe 134 to move downward.

Plate 258a moves down until it reaches divider 252d where optionally remains until filter 106 is cleaned reducing the systemic pressure exhibited across filter 106, that in turn causes piston assembly to move linearly up.

In some embodiments dividing plate 252d may be fit with and/or associated with a switching member 170 for example provided in the form of a hydraulic and/or mechanical switch and/or armature that provides for switching the position of 3/2 valve 160 back to atmospheric pressure to re-establish pressure equilibrium across plate 258a. Pressure balance across plate 258a allows for closure of flush port 254 therefore ending the cleaning phase and returning the filter to filtering phase.

FIG. 9-11 shows flowcharts, similar to those discussed with FIG. 5-7, that describe the movements and pressure flux across filter 100,101 as experienced with flush valve assembly 252 depicted in FIG. 8A-B.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

What is claimed is:

1. A self-cleaning filter apparatus (100,101) for filtering a raw flowing fluid, the apparatus including: filtering housing (110) for filtering a fluid across a screen filter (106), a flushing chamber (130) for housing filtered debris, and a control assembly (150) for controlling the transition between the different filter phases, the control assembly including a flush valve assembly (152), a three position two way (3/2) valve (160) and a differential pressure (DP) switch (165) and wherein the control assembly is characterized in that it autonomously switches between filtering phase and cleaning phase by channeling the differential pressure state along the control assembly (150).

2. The filter apparatus of claim 1 wherein said flush valve assembly (152,252) having an end in fluid communication with said flushing chamber (130) and a second end in fluid communication with said three position two way valve (160); said flush valve assembly (152,252) featuring a piston assembly (158,258), said flush valve assembly having:
a. a housing (152h, 252h) featuring a flush port (154, 254) that is in fluid communication with said flushing chamber (130); and a port (156, 256) in fluid communication with said three position two way valve (160);
b. said piston assembly (158,258) disposed internal with said housing (152h,252h), said piston assembly configured to move linearly (158L,258L) in response to a pressure differential, said piston assembly featuring a piston shaft member (158b) coupled to an upper piston plate member (158a,258a) and a lower piston plate member (158c,258c);
i. said upper piston plate member (158a,258a) is configured to be responsive to a pressure differential across its surfaces wherein an upper surface of said upper piston plate is exposed to pressure originating from said port (156,256); and a lower surface of said upper piston plate is exposed to atmospheric pressure;
ii. said lower piston plate member (158c,258c) is positioned to control flow from said flush chamber (130) to said flush port (154,254).

3. The filter assembly of claim 2 wherein piston said housing (252h) further comprises an internal dividing plate (252d) having a central bore for receiving said piston shaft (158b), wherein said dividing plate internally divides said housing into an upper portion featuring said upper piston plate (258a) and a lower portion featuring said lower piston plate (258c).

4. The filter assembly of claim 3 wherein said housing (252h) further comprises an atmospheric port (254a) disposed along the external surface of said upper portion; and wherein said flush port (254) is disposed along the external surface of said lower portion.

5. The filter assembly of claim 1 wherein said housing features an end cap (259,159) along an upper portion provided for coupling said housing with said three position two way valve (160).

6. The filter assembly of claim 5 wherein said cap features a port (156,256).

7. The filter assembly of claim 5 wherein said cap features a cap shaft (159a); a cap shaft spring (159b) and an internal flow channel (159c) and wherein said internal flow channel is in fluid communication with said port (156,256).

8. The filter assembly of claim 7 wherein said cap shaft (159a) is functionally associated with said three position two way valve (160).

9. The filter assembly of claim 3 wherein said housing upper portion features a switching member (170) that is functionally associated with said 3/2 valve (160).

10. The apparatus of claim 1 wherein an end of piston shaft (158b) is associated with a debris removal pipe (134) wherein the linear movement of said debris removal pipe (134) and said piston shaft are concerted.

11. The apparatus of claim 10 wherein a debris removal pipe (134) is coupled to debris suction module (122) such that at least one suction nozzles (124) moves in synchrony with the movement of the debris removal pipe (134).

12. The apparatus of claim 11 wherein the movement of debris removal pipe (134) further provides for controlling the on/off status of the at least one suction nozzle (124).

13. The apparatus of claim 10 wherein the suction module (122) comprises a plurality of suction nozzles (124).

14. The apparatus of claim 10 wherein the linear movement (134L) of the debris removal pipe (134) is controlled by the linear movement (120L) of the suction module (122).

15. The apparatus of claim 14 wherein linear movement (120L) of the suction module (122) further provides for controlling the on/off status of at least one suction nozzles from the plurality of suction nozzles (124).

16. The apparatus of claim 10 wherein the debris removal pipe (134) is coupled to the debris suction assembly (122), such that when in self-cleaning phase, the rotational movement of debris removal pipe (134) is configured to provide corresponding rotational movement of the at least one or more suction nozzles (124).

17. The apparatus of claim 16 wherein the debris suction assembly (122) further comprise a suction nozzle controlling member (126) that is configured to activate different suction nozzles (124) based on the linear movement (120L) of the debris suction assembly (122), the suction nozzle controlling member (126) configured to allow or prevent fluid flow through the suction nozzle (124).

18. The apparatus of claim 17 wherein the nozzle controlling member (126) comprises at least one recess opening (126o), wherein the recess (126o) is configured to align with flow pathway of the suction nozzle (124) therein allowing fluid to flow therethrough, therein activating the suction nozzle; and wherein the nozzle controlling member (126) having a portion that blocks/prevents fluid flow through the nozzle member (124).

19. The apparatus of claim 18 wherein the nozzle controlling member (126) is disposed through a portion of suction nozzle (124) intercepting the nozzles flow path.

20. The apparatus of claim 19 wherein the nozzle controlling member (126) is disposed at an end of the suction nozzle (124).

21. The apparatus of claim 19 activation member (126) configured to have a plurality of activation recess openings (126o) corresponding to the number of suction nozzles (124) being controlled.

22. The apparatus of claim 19 wherein nozzle controlling member (126) is associated with the debris suction module (122) such the linear position of that suction module (122) determines which nozzle is activated.

23. The apparatus of claim 10 wherein the debris removal pipe (134) is coupled to the filter assembly (102) such that when in self-cleaning phase, the movement of debris removal pipe (134) is configured to provide corresponding and simultaneous movement of a filtering member (106), wherein the movement provides for dislodging debris from the filter member (106).

24. The apparatus of claim 23 wherein the direction of flow across the filtering member (106) is configured to be inside out, wherein an inner surface of the filtering member (106) is configured to be the active filter surface (106f).

25. The apparatus of claim 23 wherein the suction module (122) is disposed internal to the filter within an internal open volume, wherein the at least one suction nozzle (124) of the suction module (122) provides for sweeping the internal active filter surface (106f).

26. The apparatus of claim 23 wherein the direction of flow across the filtering member (106) is configured to be outside in, wherein an outer surface of the filtering member (106) is configured to be the active filter surface (106f).

27. The apparatus of claim 26 wherein the suction module (122) is disposed external to the filter (106), wherein the at least one suction nozzle (124) of the suction module (122) provides for sweeping the external active filter surface (106f).

28. The apparatus of claim 1 wherein the filter is remotely controlled by remotely controlling the status of DP switch (165).

29. The apparatus of claim 28 wherein the remote means comprise a remotely controllable valve, switch, motor, actuator, piston or the like.

30. The apparatus of claim 28 wherein said DP switch (165) is provided with an indicator (167) provided in the form selected from handle, rotating handle, or any combination thereof.

31. A cleaning module for a self-cleaning screen filter apparatus the cleaning module comprising:
a. at least one suction nozzle (124) having a flow path between a first end and a second end associated over a filtering surface of said screen filter and configured for suctioning debris away from said screen filter, said suction nozzle having a first end associated over the filtering surface of said screen filter; a second end in communication with a retrieval pipe;
b. said retrieval pipe in fluid communication with said suction nozzle (124) and configured to receive debris flow collected with said suction nozzle; and
c. a nozzle controlling member (126) placed along and intercepting said nozzle flow path and configured so as to control the flow through said suction nozzle (124).

32. The cleaning module of claim 31 wherein said control member (126) provides for controlling the degree of flow through said nozzle flow path.

33. The cleaning module of claim 31 wherein said control member provides for opening or blocking the flow through said nozzle flow path.

34. The cleaning module of claim 31 configured to be moveable along the surface of said filter.

35. The cleaning module of claim 34 wherein the movement is rotational or linear.

36. The cleaning module of claim 35 wherein at least one of said linear movement or said rotatable movement provides for controlling the position of said control member relative to said nozzle flow path.

37. The cleaning module of claim 36 wherein the linear movement of said cleaning module provides for controlling the position of said control member (126) relative to said nozzle flow path so as to fully open or fully block the flow path.

38. The cleaning module of claim 31 further comprising a plurality of suction nozzles (124).

39. The cleaning module of claim 38 wherein each suction nozzle is provided with an individual control member (126).

40. The cleaning module of claim 38 wherein at least two suction nozzles (124) are provided with a common control member (126).

41. The cleaning module of claim 38 comprising a plurality of suction nozzles (124) wherein a group of suction nozzles are controlled with a common control member (126).

42. The cleaning module of claim 38 comprising a plurality of control members (126) each provided for controlling a group of suction nozzles (124).

43. The cleaning module of claim 38 wherein each suction nozzle (124) may be controlled with at least two control members (126).

44. The cleaning module of claim 31 wherein each nozzle flow path is controlled with at least two control members (126)

45. The cleaning module of claim 31 wherein said control member is a shaft having at least one recess defining an opening.

46. The cleaning module of claim 31 wherein said control member comprises a plurality of recessed opening along its length.

47. The cleaning module of claim 46 wherein said plurality of opening are of variable sizes.

48. The cleaning module of claim 45 wherein said at least one recess opening is provided with a diameter equal to the diameter of said flow path.

49. The cleaning module of claim 45 wherein the linear position of said controlling member (126)determines which nozzle is activated.

50. A fluid filter cleaning apparatus comprising: a housing having an inlet port, an outlet port and a valved flushing outlet, said housing defining a fluid passage between said ports via a filtering member; a filter cleaning module according to any one of claims 31-49 that is movably mounted within said housing and having at least one suction nozzle adapted to move in close proximity to the surface of the filtering member and to provide a fluid flow path between said intake portion and said valved cleaning outlet; and a fluid responsive means (134) positioned in said flow path adapted to cause the movement of said cleaning body; the arrangement being such that when said filter is at least partly clogged said valved flushing outlet is opened causing fluid to flow via said suction nozzle through said cleaning module into said cleaning outlet and thereby to actuate said fluid responsive means to cause the movement of said cleaning module; and wherein the movement of said cleaning module provides for actuating said control member (126) so as to control the degree of flow through said nozzles.

51. The filter apparatus of claim 1 further comprising a three position hydraulic valve relay (140) that is in fluid communication with control assembly (150).

52. The filter apparatus of claim 51 wherein said fluid communication is provided by piping wherein said relay (140) is further in fluid communication between both flush valve assembly (152) and with said 3/2 valve (160).

53. The filter apparatus of claim 51 wherein said three position hydraulic valve relay (140) is configured to be a normally open three position hydraulic valve relay.

54. A filter control module (150) for a self-cleaning filter apparatus, the filter control module provided for controlling the transition between a filtering phase and a cleaning phase of said filter apparatus, the control assembly is characterized in that it autonomously switches between filtering phase and cleaning phase by channeling the differential pressure state of the filter apparatus, the control module (150) including:
a. a differential pressure (DP) switch (165) featuring a high pressure zone (165H) featuring a high pressure port (165a) and a low pressure zone (165L) featuring a low pressure port (165b); wherein said high pressure port (165a) is in fluid communication with the filter assembly's high pressure zone; and wherein said low pressure port (165b) is in fluid communication with the filter assembly's low pressure zone; said DP switch (165) is sensitive to a threshold differential pressure sensed between said high pressure port (165a) and said low pressure port (165b); said DP switch (165) is functionally associated with a three position two way (3/2) valve (160) wherein said DP switch (165) actuates said three positon two way valve (160) when said threshold is reached;
b. said three position two way valve (160); having an outlet port (162a) and a first inlet port (162b) and a second inlet port (162c); wherein said first inlet port (162b) is in fluid communication with the filter assembly's high pressure zone; said second inlet port (162c) is in fluid communication with atmospheric pressure; and wherein said outlet port (162a) exhibits pressure equal to one of said inlet ports (162c,162b); said outlet port (162a) is in fluid communication with a flush valve assembly (152,252) via a port (156,256) so as to communicate the pressure from said outlet port (162a) to said flush valve assembly (152);
c. said flush valve assembly (152,252) featuring a piston assembly (158,258), said flush valve assembly having:
i. a housing (152h, 252h) featuring a flush port (154, 254) and a port (156, 256) in fluid communication with said three position two way valve (160);
ii. said piston assembly (158,258) disposed internal with said housing (152h,252h), said piston assembly configured to move linearly (158L,258L) in response to a pressure differential, said piston assembly featuring a piston shaft member (158b) coupled to an upper piston plate member (158a,258a) and a lower piston plate member (158c,258c); said upper piston plate member (158a,258a) is configured to be responsive to a pressure differential across its surfaces wherein an upper surface of said upper piston plate is exposed to pressure originating from said port (156,256); and a lower surface of said upper piston plate is exposed to atmospheric pressure; said lower piston plate member (158c,258c) is positioned to control flow from the filter assembly to said flush port (154,254).

55. The control module of claim 54 wherein said piston housing (252h) further comprises an internal dividing plate (252d) having a central bore for receiving said piston shaft (158b), wherein said dividing plate internally divides said housing into an upper portion featuring said upper piston plate (258a) and a lower portion featuring said lower piston plate (258c).

56. The control module of claim 55 wherein said housing (252h) further comprises an atmospheric port (254a) disposed along the external surface of said upper portion; and wherein said flush port (254) is disposed along the external surface of said lower portion.

57. The control module of claim 54 wherein said housing features an end cap (259,159) provided for associating said housing with said three position two way valve (160).

58. The control module of claim 57 wherein said cap features said port (156,256).

59. The control module of claim 58 wherein said cap features a cap shaft (159a); a cap shaft spring (159b) and an internal flow channel (159c) and wherein said internal flow channel is in fluid communication with said port (156,256).

60. The control module of claim 59 wherein said cap shaft (159a) is functionally associated with said three position two way valve (160).

61. The control module of any of claims 54-60 further comprising a three position hydraulic valve relay (140).

62. The control module of claim 61 wherein said relay (140) is in fluid communication between both flush valve assembly (152) and with said 3/2 valve (160).

63. The control module of claim 61 wherein said three position hydraulic valve relay (140) is configured to be a normally open three position hydraulic valve relay.
